(19) United States
(12) Patent Application Publication
(10) Pub. No.: US 2012/0253508 A1
(43) Pub. Date: Oct. 4, 2012

(54) POINT OF DISPLAY INVENTORY CONTROL APPARATUS AND SYSTEM

(76) Inventor: William K. Holmes, San Diego, CA (US)

(21) Appl. No.: 13/437,457

(22) Filed: Apr. 2, 2012

Related U.S. Application Data
(60) Provisional application No. 61/470,675, filed on Apr. 1, 2011.
(60) Provisional application No. 61/478,048, filed on Apr. 21, 2011.

(51) Int. Cl. A47F 5/00; G05D 3/00

(52) U.S. Cl. 700/232; 211/4

(57) ABSTRACT

An apparatus for displaying merchandise on a support structure includes a base configured to couple to the support structure, a control member supported by the base, and a locking mechanism supported by the base. The base includes a guide member configured to support a plurality of items for display. The control member includes a control wheel that is rotatable relative to the guide member to selectively allow removal of an item from the guide member. The locking mechanism is movable between a first state, in which the locking mechanism engages the control wheel to inhibit rotation of the control wheel relative to the guide member, and a second state, in which the locking mechanism disengages the control wheel to allow rotation of the control wheel relative to the guide member.

### CROSS-REFERENCE TO RELATED APPLICATIONS

This application claims priority to U.S. Provisional Patent Application No. 61/470,675, filed Apr. 1, 2011, and to U.S. Provisional Patent Application No. 61/478,048, filed Apr. 21, 2011, the entire contents of both of which are incorporated by reference herein.

### FIELD OF THE INVENTION

Embodiments of the present invention relate to apparatuses, systems, and methods for controlling access to inventory displayed for purchase or use.

### BACKGROUND

The retail industry has long faced a challenge in maintaining the security and accurate inventory of merchandise displayed for customers to examine and select prior to purchase. Typically, merchandise is displayed on a variety of open shelves, racks, pegs, hooks, bins, etc. Such display methods make it easy for a customer to examine merchandise; however, such display methods do not provide good control over the merchandise. In some instances, customers examining the displayed merchandise may return the merchandise to an incorrect location or leave the merchandise at another location in the store. Accordingly, the inventory of merchandise at the display location is inaccurate, interfering with a store's ability to maintain and monitor accurate inventory. Accordingly, the store must employ staff to continually check displays to make sure that merchandise is properly displayed. In other instances, customers and/or store staff steal displayed merchandise. Theft of displayed merchandise not only interferes with a store's ability to maintain and monitor accurate inventory, but also leads to significant losses for a store and the retail industry as a whole.

In response to the above challenges, stores have employed various approaches to display and control inventory. These approaches have included the use of locked display cabinets, glass cases, cages, and display racks with cylinder locks on the rack pegs to prevent removal of merchandise. The display of merchandise in a locked cabinet, case, or cage prevents a customer from freely inspecting merchandise. Furthermore, the use of all of the aforementioned devices prevents a customer from examining, selecting, or purchasing merchandise on their own. Instead, the customer must locate a store employee and wait for the store employee to unlock the secured merchandise before the customer can examine and select the merchandise.

Alternatively, stores have utilized various security tags, such as RFID tags, to prevent theft of merchandise. Such security tags allow a customer to examine merchandise within a store; however, the tags do not prevent a customer from leaving the merchandise at an incorrect location or at a new location in the store. In addition, security tags can be removed from merchandise, or otherwise defeated, such that a person can steal merchandise without detection.

In addition, stores have employed various other means of security including video surveillance, monitoring software, and uniformed or undercover security agents. These methods are implemented at great costs to stores, in an attempt to deter theft. The effectiveness of such methods is limited by the costs required to constantly monitor an entire retail space. Furthermore, these methods do not provide customers with any information about the merchandise they are interested in purchasing.

### SUMMARY

Embodiments of the invention provide an apparatus and system for displaying merchandise for purchase or use, while at the same time controlling access to the merchandise. In some embodiments, the point of display inventory control apparatus and system provides an inventory control device that allows access to merchandise to be granted to a user (e.g., a customer) by a remotely located customer service representative. In other embodiments, the inventory control device can allow access to merchandise without requiring the authorization of a customer service representative, but after, for example, payment for the merchandise or a time delay.

In one embodiment, the invention provides an apparatus for displaying merchandise on a support structure. The apparatus includes a base configured to couple to the support structure. The base includes a guide member configured to support a plurality of items for display. The apparatus also includes a control member supported by the base. The control member includes a control wheel that is rotatable relative to the guide member to selectively allow removal of an item from the guide member. The apparatus further includes a locking mechanism supported by the base. The locking mechanism is movable between a first state, in which the locking mechanism engages the control wheel to inhibit rotation of the control wheel relative to the guide member, and a second state, in which the locking mechanism disengages the control wheel to allow rotation of the control wheel relative to the guide member.

In another embodiment, the invention provides an apparatus for displaying merchandise on a support structure. The apparatus includes a base configured to couple to the support structure. The base includes a guide member configured to support a plurality of items for display. The apparatus also includes a control member supported by the base. The control member is movable relative to the guide member to selectively allow removal of an item from the guide member. The apparatus further includes a locking mechanism supported by the base. The locking mechanism includes an electronically-actuated member that is movable between a first state, in which the locking mechanism inhibits movement of the control member relative to the guide member, and a second state, in which the locking mechanism allows movement of the control member relative to the guide member.

In yet another embodiment, the invention provides an apparatus for displaying merchandise on a support structure. The apparatus includes a base configured to couple to the support structure. The base includes a guide member configured to support a plurality of items for display. The apparatus also includes a control member supported by the base. The control member is movable relative to the guide member to selectively allow removal of an item from the guide member. The apparatus further includes a locking mechanism supported by the base. The locking mechanism is movable between a first state, in which the locking mechanism inhibits movement of the control member relative to the guide member, and a second state, in which the locking mechanism allows movement of the control member relative to the guide member. The apparatus also includes an actuator supported by the base. The actuator is manually operable to actuate one of the control member and the locking mechanism to release the item from the guide member.

In still another embodiment, the invention provides a system for displaying merchandise including a support structure and a plurality of inventory display apparatuses. Each inventory display apparatus includes a base mounted to the support structure. The base includes a guide member configured to support a plurality of items for display. Each apparatus also includes a control member supported by the base. The control member is movable relative to the guide member to selectively allow removal of an item from the guide member. Each apparatus further includes a locking mechanism supported by the base. The locking mechanism is movable between a first state, in which the locking mechanism inhibits movement of the control member relative to the guide member, and a second state, in which the locking mechanism allows movement of the control member relative to the guide member. The system also includes a controller coupled to the plurality of inventory display apparatuses. The controller is operable to control the locking mechanism of each inventory display apparatus. The system further includes a user interface mounted to the support structure and coupled to the controller. The user interface is operable to transmit a signal to the controller to selectively move the locking mechanism of each inventory display apparatus from the first state to the second state.

In other embodiments, the invention provides methods for dispensing items using the above system and/or apparatuses, or other similar devices.

Other aspects of the invention will become apparent by consideration of the detailed description and accompanying drawings.

### BRIEF DESCRIPTION OF THE DRAWINGS

FIG. 1 is a perspective view of a point of display inventory control system embodying the invention.

FIG. 2 is a schematic of the point of display inventory control system of FIG. 1.

FIG. 3 is a perspective view of an inventory display apparatus for use with the system shown in FIG. 1.

FIG. 4 is another perspective view of the inventory display apparatus of FIG. 3.

FIG. 5 is a front end view of the inventory display apparatus of FIG. 3.

FIG. 6 is a perspective view of the inventory display apparatus of FIG. 3 with a portion of a cover removed to show internal components.

FIG. 7 is a top view of the inventory display apparatus of FIG. 3 with the portion of the cover removed.

FIG. 8 is a bottom view of a portion of the inventory display apparatus of FIG. 3.

FIG. 9 is a perspective view of a portion of the inventory display apparatus of FIG. 3.

FIG. 10 is a bottom view of a portion of another embodiment of an inventory display apparatus.

FIG. 11 is a bottom view of a portion of yet another embodiment of an inventory display apparatus.

FIG. 12 is a perspective view of a packaging adapter for use with the inventory display apparatus shown in FIG. 3.

FIG. 13 is another perspective view of the packaging adapter of FIG. 12.

FIG. 14 is a perspective view of still another embodiment of an inventory display apparatus.

FIG. 15 is a perspective view of a portion of the inventory display apparatus of FIG. 14 with a portion of a cover removed to show internal components.

FIG. 16 is a top view of a portion of the inventory display apparatus of FIG. 14 with a portion of the cover removed.

FIG. 17 is a perspective view of yet still another embodiment of an inventory display apparatus.

FIG. 18 is a side view of the inventory display apparatus of FIG. 17.

FIG. 19 is a front end view of the inventory display apparatus of FIG. 17.

FIG. 20 is a rear perspective view of the inventory display apparatus of FIG. 17.

FIG. 21 is a perspective view of the inventory display apparatus of FIG. 17 with a cover removed.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

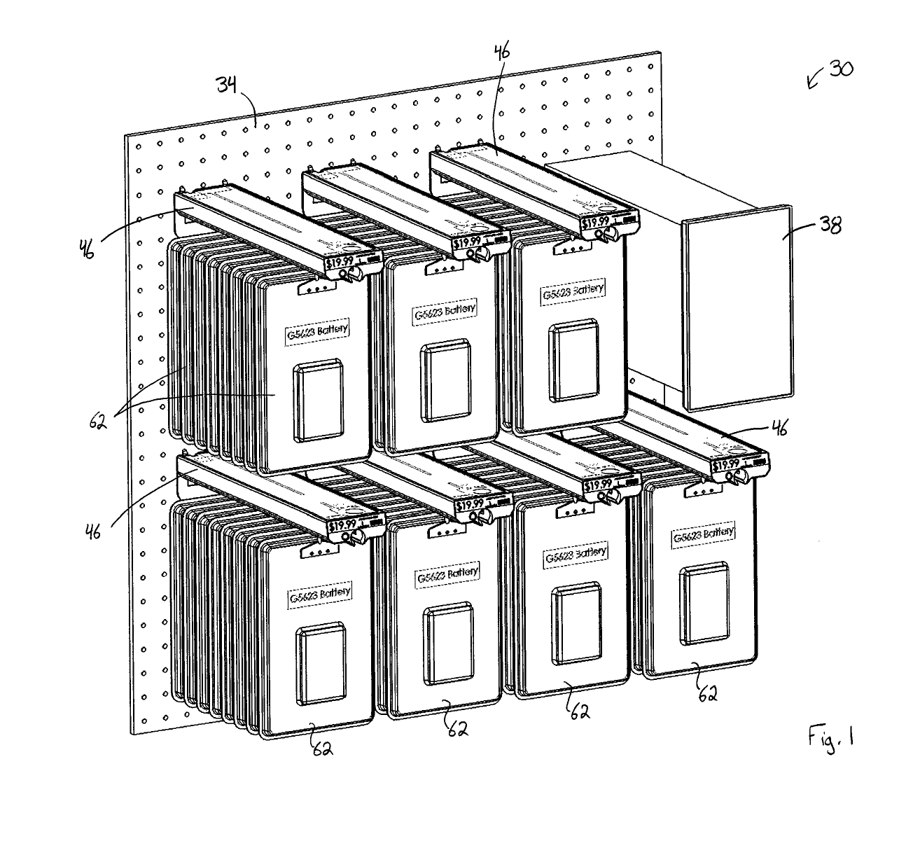

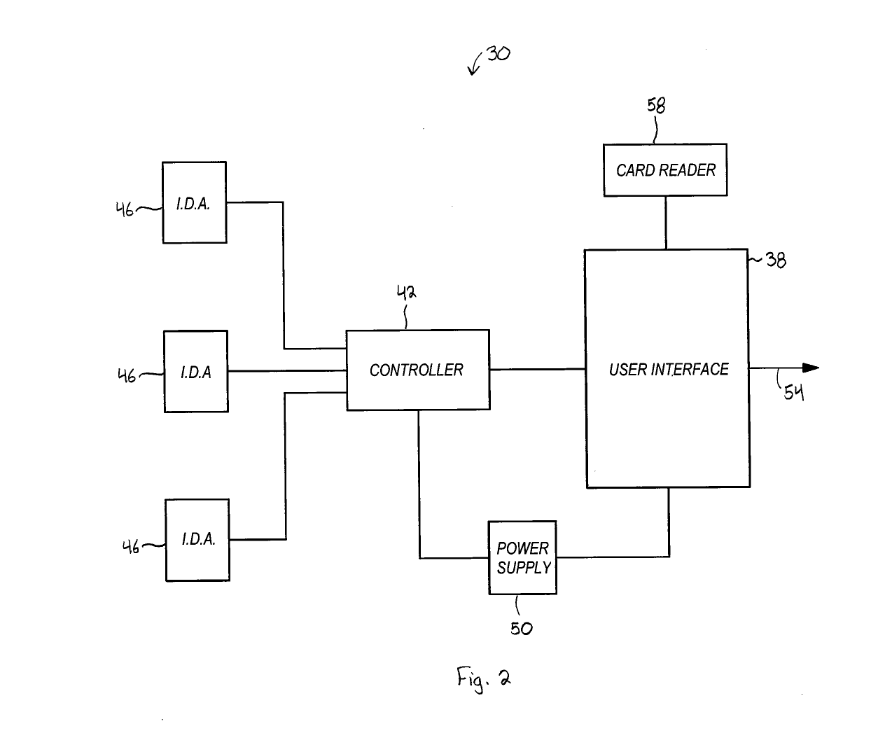

FIGS. 1 and 2 illustrate an inventory control system 30 for displaying merchandise for purchase or use, while at the same time controlling access to the merchandise. The illustrated system 30 allows access to merchandise to be granted to a user (e.g., a customer) by an on-site customer service representative or a remotely located customer service representative. The system 30 may also be unattended such that the user is granted access to the merchandise by paying for the merchandise or entering information into the system 30 without requiring authorization from a customer service representative.

In the illustrated embodiment, the inventory control system 30 includes a support structure 34, a user interface 38, a controller 42, and a plurality of inventory display apparatuses 46. The support structure 34 supports the other components of the system 30 in a store or other point of display location. The illustrated support structure 34 is a standard display pegboard. In other embodiments, the support structure 34 can include any suitable type of frame, wall, or surface for supporting and displaying merchandise, such as, for example, a rack, a shelving unit, a cart, a kiosk, or the like.

The user interface 38 is mounted to the support structure 34 and coupled to the controller 42. The user interface includes software, or other non-transitory computer readable mediums, that allows a user to interact with the system 30. For example the user interface 38 allows a user to select merchandise being supported by one of the inventory display apparatuses 46 and request release of the merchandise. In addition, the user interface 38 can provide a user with information regarding the type of merchandise displayed in the system 30, the location of certain merchandise in the system 30, the cost of the merchandise, the location of other merchandise within the store, the availability of certain merchandise, and other information relating to the merchandise. In the illustrated embodiment, the user interface 38 includes a touch screen. The user interface 38 can also include, for example, a keyboard, a keypad, a microphone, a speaker, a camera, a video display, and/or any other input/output device to facilitate interaction with the system 30.

The user interface 38 is connected to a power supply 50 (FIG. 2) that powers the interface 38 and other components of the system 30. In some embodiments, the power supply 50 may be a wall outlet in a store. In other embodiments, the power supply 50 may be a battery, generator, or other dedicated power source such that the system 30 can still operate when positioned at a location where wall outlets are not readily available.

As shown in FIG. 2, the system 30 also includes a network connection 54 coupled to the user interface 38. In other embodiments, the network connection 54 can be coupled to the controller 42. The network connection 54 can connect the user with a customer service representative located, for example, within the store or at an offsite call center. The customer service representative can interact with the system 30 via a computer or mobile device, such as a tablet. Customer service calls generated by the user interface 38 can be optimally routed to a customer service representative based upon various criteria including the preferred language of the customer, the type of merchandise selected, information about the customer based on his or her customer loyalty card, and availability of the representative. Calls can also be routed to optimally reduce the wait time for a customer at the user interface 38 by routing calls to multiple customer service representatives (“first pick up—first connect”) or by sequentially routing the call to different representatives in order of preference (for example, starting with an in-store clerk, then an in-store manager, then an off-site call center, etc.). Via the user interface 38, the customer service representative can assist a user with the merchandise purchase by answering questions, recommending alternate or ancillary products, and by releasing locking mechanisms on the inventory display apparatuses 46. If needed, the customer service representative can direct the user to a different product or other display system if the user is interested in other merchandise.

In some embodiments, such as the illustrated embodiment, the user interface 38 can include a card reader 58. The card reader 58 can facilitate release of requested merchandise by accepting payment at the user interface 38 with a credit card, debit card, gift card, customer loyalty card, or the like. In such embodiments, the user interface 38 can function as the point of sale for the merchandise and can provide the customer with additional information (e.g., receipts, coupons, use/assembly instructions, warranty information, etc.) in paper or electronic form. In addition, by accepting payment at the user interface 38, the customer may be granted access to the merchandise without receiving authorization from a customer service representative. In other embodiments, the customer may prepay for the merchandise and enter in an authorization or validation code at the user interface 38 to release the merchandise. In still further embodiments, the customer may pay for the merchandise via an electronic transfer from, for example, a cell phone.

In some embodiments, the user interface 38 can include voice recognition software and can provide information, service, or release of merchandise based on verbal commands (with or without the interaction with a customer service representative). Additionally or alternatively, the user interface 38 can include a motion detection sensor such that the user interface can “come to life” when a customer approaches the system 30. In such embodiments, the user interface 38 can offer to assist the customer and/or initiate a connection with a customer service representative so that the customer is immediately offered assistance by the representative via the user interface 38.

In some embodiments, the user interface 38 can be configured to display a greeting (e.g., “Touch Here For Service”) in multiple languages (e.g., English, Spanish, French, German, Japanese, etc.). Accordingly, a user can select the language in which he or she would prefer to receive information and/or communicate with a customer service representative.

In embodiments where the user interface 38 includes a camera, the interface 38 can record and transmit information regarding a user's face, facial expressions, or body language. The system 30 can use this type of information to gather and interpret customer purchasing data, such as purchasing patterns, responses to customer service assistance, or the like.

In some embodiments, the user interface 38 can be programmed to display advertisements or other media programming. Such programming can be selected based on the merchandise in the vicinity of the user interface 38. For example, a user interface associated with a display of cell phones can be programmed to display advertisements related to cell phone service plans or accessories (e.g., batteries, cases, screen protectors, etc.) for cell phones. In further embodiments, the user interface 38 can be programmed to have an on-screen personality, or avatar, that interacts with and assists the user.

In some embodiments, the user interface 38 can include various devices for identifying a user including, for example, identification card readers and/or biometric screening devices (e.g., retina scanners, fingerprint scanners, etc.). In such embodiments, the system 30 can be programmed to release merchandise based on the identification of the user rather than on authorization from a customer service representative. For example, the system 30 can be programmed to release certain merchandise when a user's identity is confirmed. Alternatively, if access to a product is restricted due to age (such as tobacco or alcohol), the user interface 38 can verify the age of the user by a credit card or state issued identification before the product is released. The user interface 38 can also be configured to recognize a user and authorize the user to load or stock new inventory on the inventory display apparatuses 46. In such embodiments, after the user is identified, the inventory display apparatuses 46 can be set to an “open” or unlocked mode to allow the user to add new inventory to the apparatuses 46.

As shown in FIG. 2, the controller 42 is coupled to the user interface 38 and the inventory display apparatuses 46. The controller 42 can be mounted to and supported by the support structure 34 (FIG. 1) in a location not visible to a user. Alternatively, the controller 42 can be integrated into and part of the user interface 38. Alternatively, the controller 42 can be located remotely from the support structure 34 and connected to user interfaces and display apparatuses of multiple inventory control systems such that one controller controls operation of more than one system. The illustrated controller 42 is also connected to the power supply 50 such that the controller 42 can control and provide power to the inventory display apparatuses 46. In some embodiments, the controller 42 (rather than or in addition to the user interface 38) may be connected to the network connection 54. In the illustrated embodiment, the controller 42 is coupled to the other components via wires. In other embodiments, the controller 42 may be wirelessly connected to the user interface 38 and/or the inventory display apparatuses 46.

The controller 42 can transmit data between the user interface 38 and the inventory display apparatuses 46. For example, the controller 42 includes a processor and memory to monitor the type, quantity, and location of merchandise currently being displayed by the apparatuses 46 within the system 30. The controller 42 transmits this data to the user interface 38, which provides the information to a user. When a user selects a product for release from the system 30, the user interface 38 transmits a signal to the controller 42, which then unlocks and releases the product from the corresponding inventory display apparatus 46. The controller 42 thereby provides a signal to each inventory display apparatus 46 to release or receive merchandise, and receives a signal from each apparatus 46 indicating the removal or addition of merchandise. The user interface 38 can also transmit a signal to the controller 42 that instructs the controller 42 to activate an indicator (e.g., a light, a speaker, etc.) to help a user identify the location of a product, instructs the controller 42 to perform an inventory count, or the like.

The controller 42 can be used with multiple different types of inventory display apparatuses including, for example, apparatuses for use with boxed goods and tagged goods. In such embodiments, the controller 42 can be configured so that it can control different types of apparatuses without special programming or parameters. Accordingly, a store can configure a retail display with multiple different inventory display apparatuses connected to a single controller.

Although features of the inventory control system 30 have been described with reference to particular components of the system 30, these features can be associated with other components of the system 30. In addition, although the components of the system 30 have been described separately, the components of the system 30 can be combined in any suitable construction (for example, in certain embodiments the controller 42 and user interface 38 can be a single unit). In further embodiments, the system 30 can be integrated into existing store systems or networks, or used in conjunction with existing store systems or networks. For example, the display inventory control system 30 can be connected to and work with a store's existing security system, video surveillance system, and inventory ordering system.

In further embodiments, the system 30 may include additional components to facilitate the return of merchandise selected and removed from an inventory display apparatus, but not purchased by a customer. Such embodiments may include a return box that allows a piece of merchandise to be scanned in and returned to a secure container for restocking by store employees.

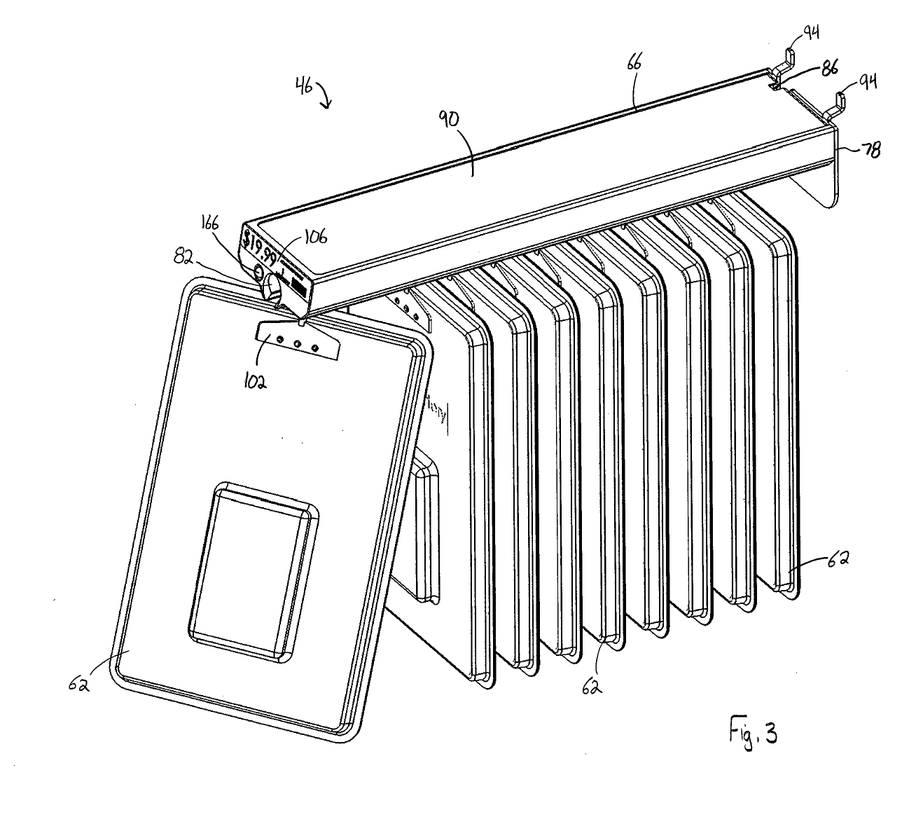

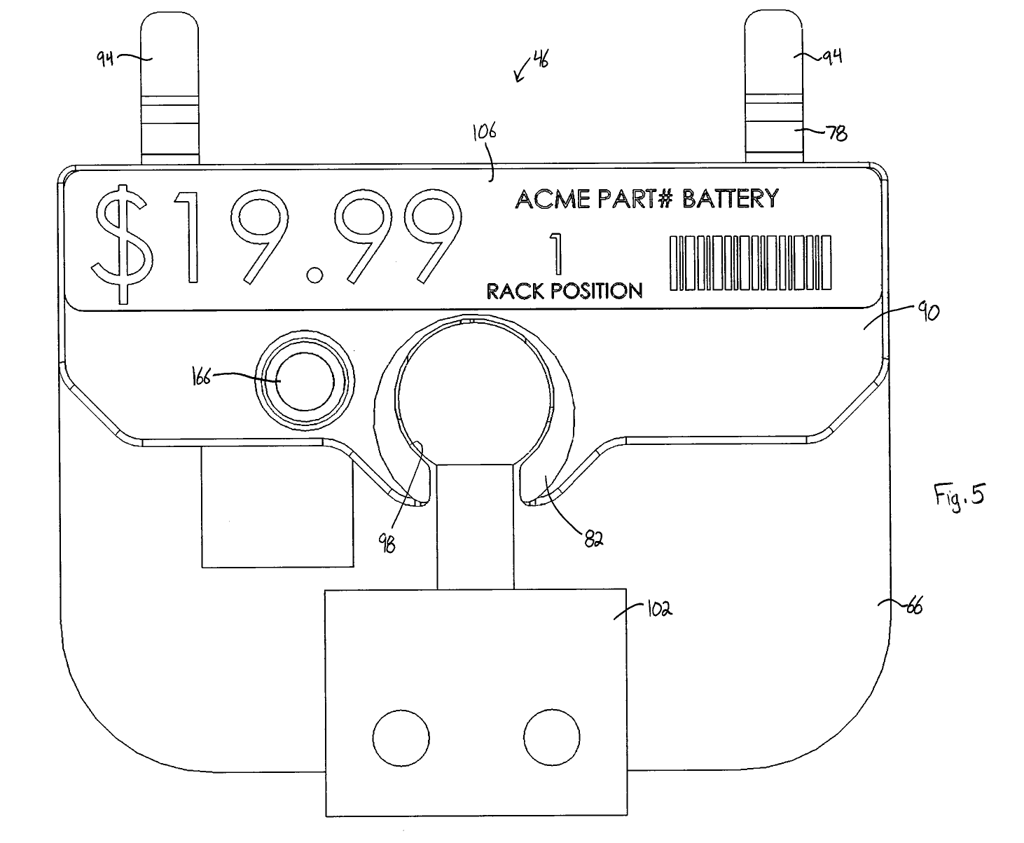

FIGS. 3-7 illustrate one of the inventory display apparatuses 46 in more detail. The apparatus 46 is configured to support a plurality of products 62 for display on the support structure 34. The apparatus 46 allows selective access to the products 62 by locking or retaining the products 62 on the apparatus 46 until the apparatus 46 receives a release signal from the controller 42. In the illustrated embodiment, the apparatus 46 includes a base 66, a control member 70, and a locking mechanism 74.

The base 66 physically connects the inventory display apparatus 46 to the support structure 34 and electrically connects the apparatus 46 to the other components (e.g., the controller 42 and the user interface 38) of the system 30. The illustrated base 66 includes a mounting mechanism 78, a guide member 82, an electrical connector 86, and a cover 90. In the illustrated embodiment, the mounting mechanism 78 includes a pair of hooks 94 for attaching the apparatus 46 to, for example, a pegboard. In other embodiments, the mounting mechanism 78 can include any suitable mounting structure for attaching the apparatus 46 to a desired support structure, such as brackets, fasteners, pin joints, adhesives, magnets, or the like.

The guide member 82 includes a channel 98, or track, formed in the base 66. The channel 98 is formed in a bottom surface of the base 66 and extends outwardly from the support structure 34. The channel 98 is configured to receive packaging adapters 102 to hang the products 62 from the apparatus 46. In other embodiments, the guide member 82 can include any suitable support or guide for displaying merchandise, such as, for example, rods, bars, trays, or carousels. In still other embodiments, the guide member 82 can be arranged horizontally, vertically, or at any suitable angle for the display of merchandise. In further embodiments, the guide member 82 can be a vertical or horizontal column dispenser. In the illustrated embodiment, the guide member 82 is integrally formed with the base 66. In other embodiments, the guide member 82 may be formed in or as part of a separate component that is attached to the base 66.

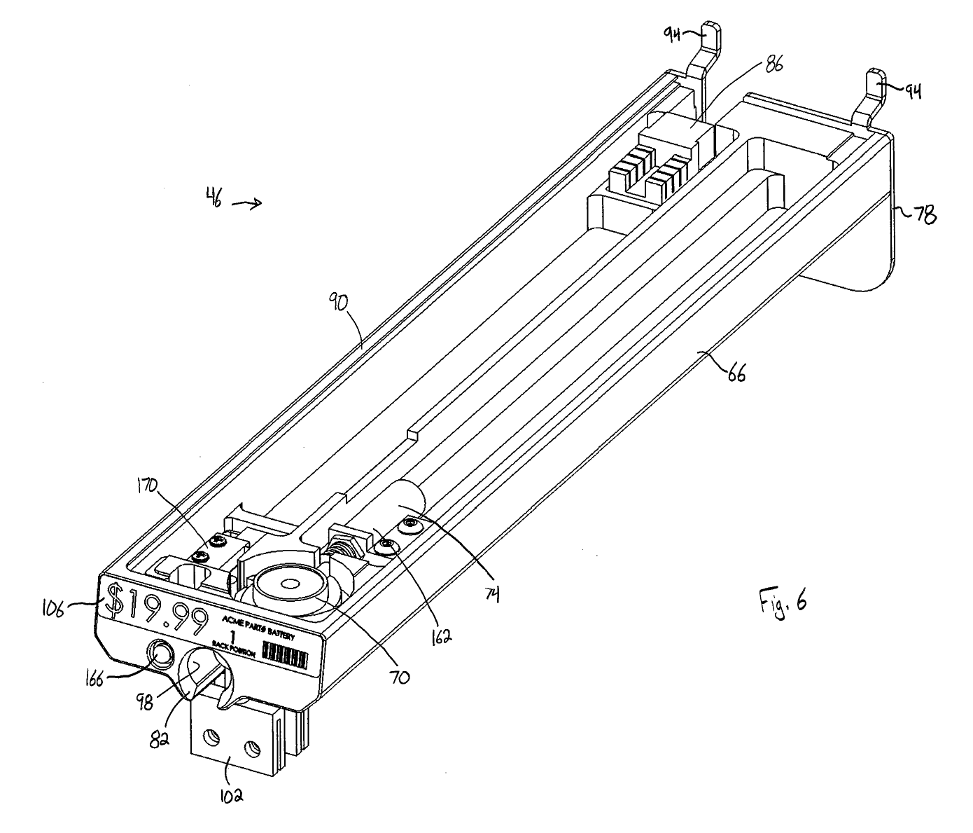

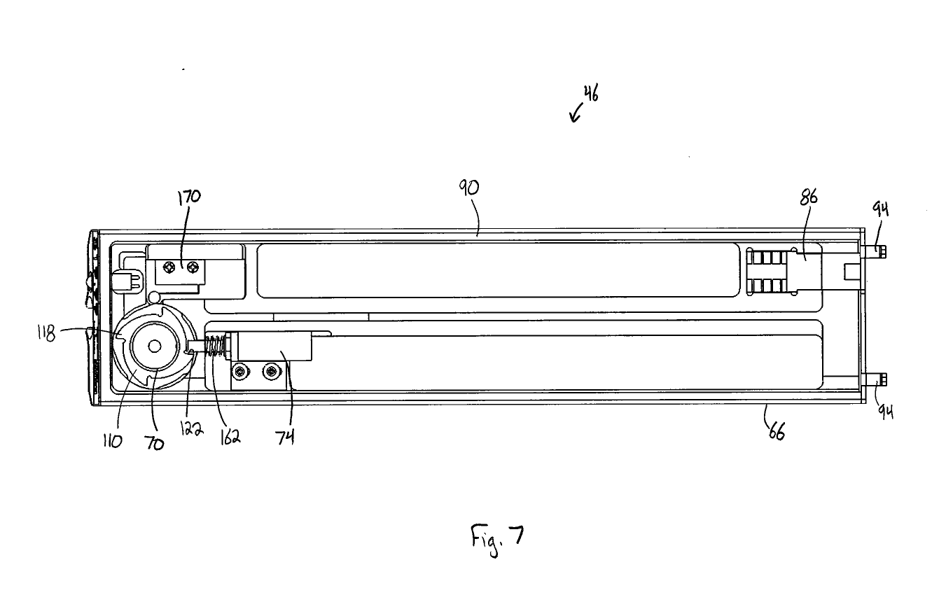

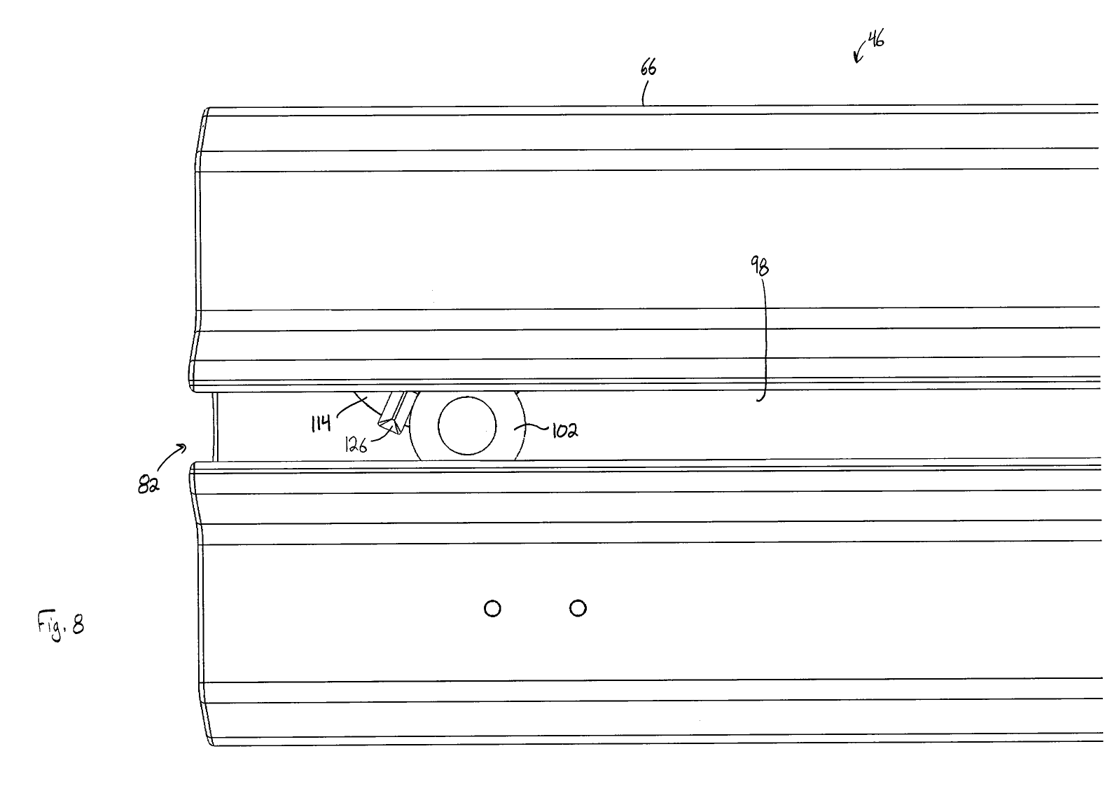

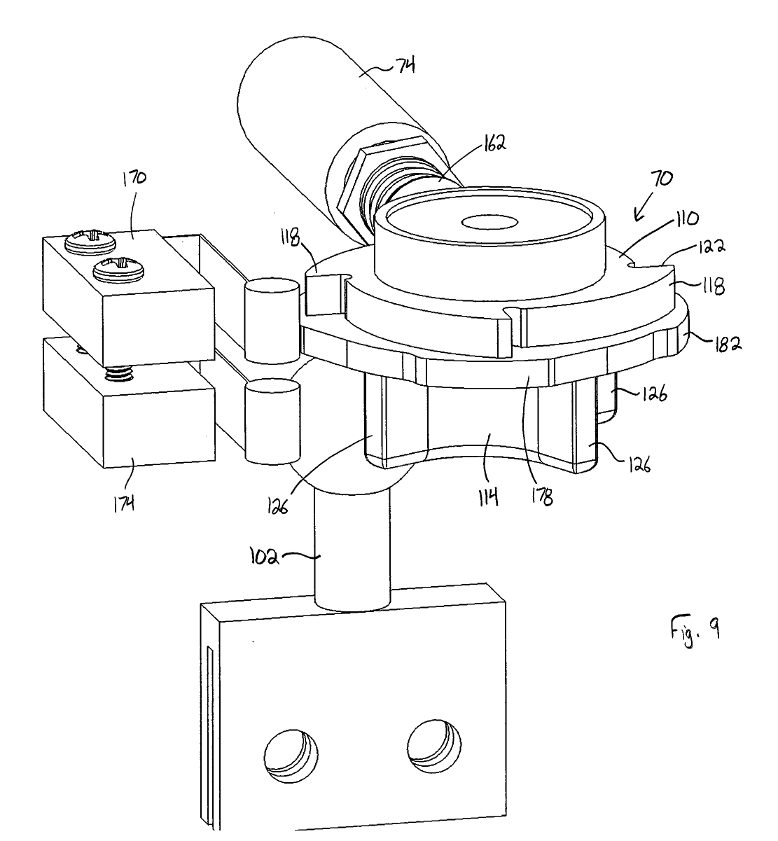

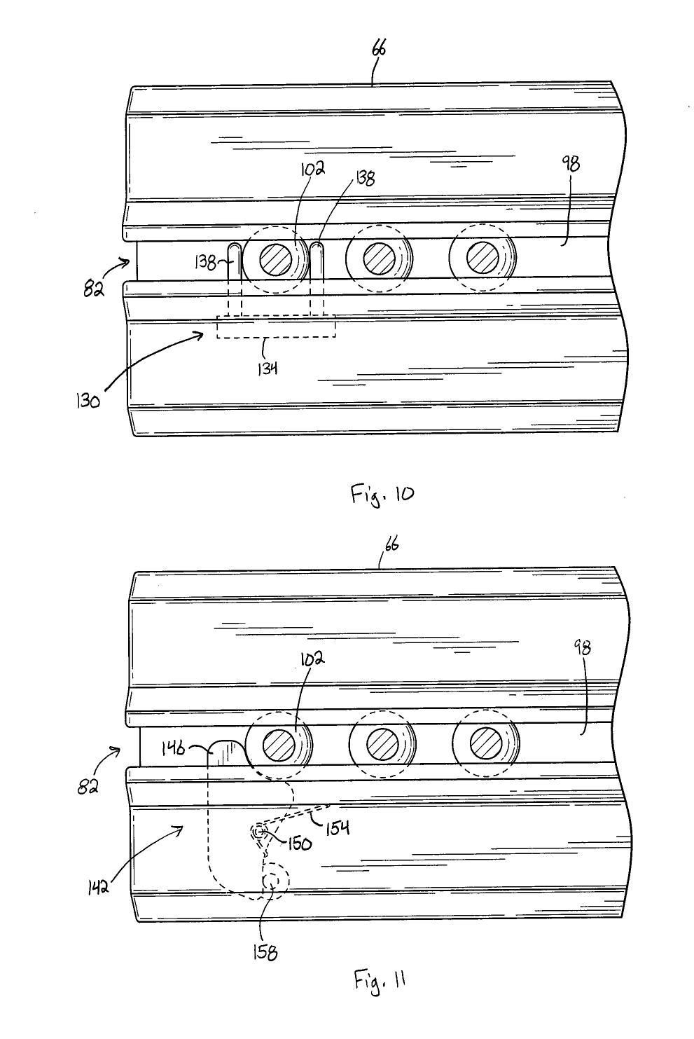

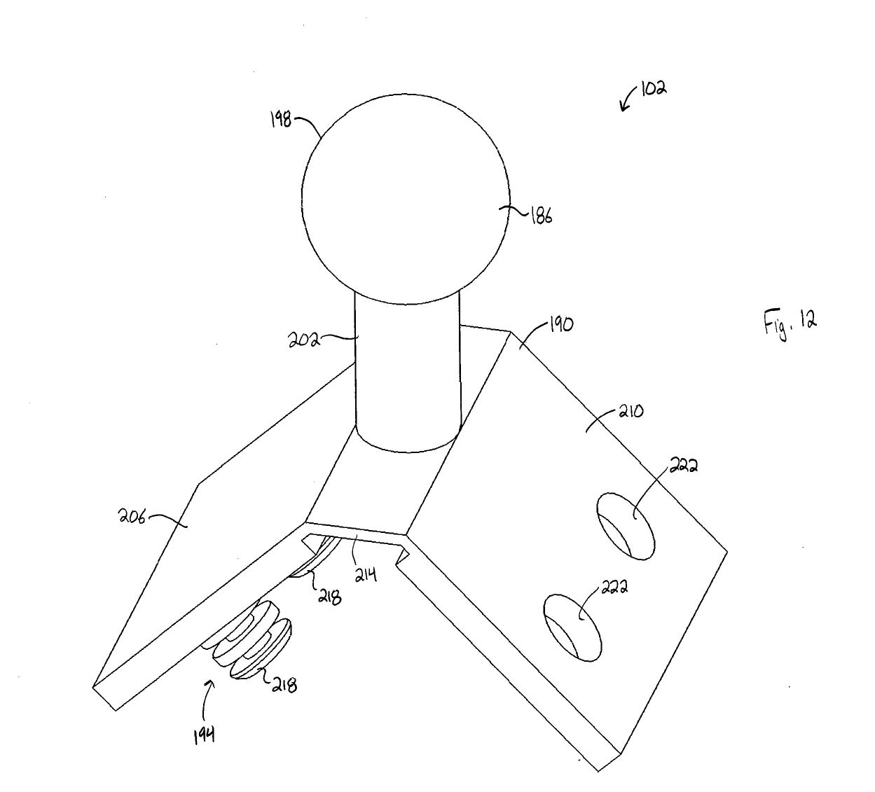

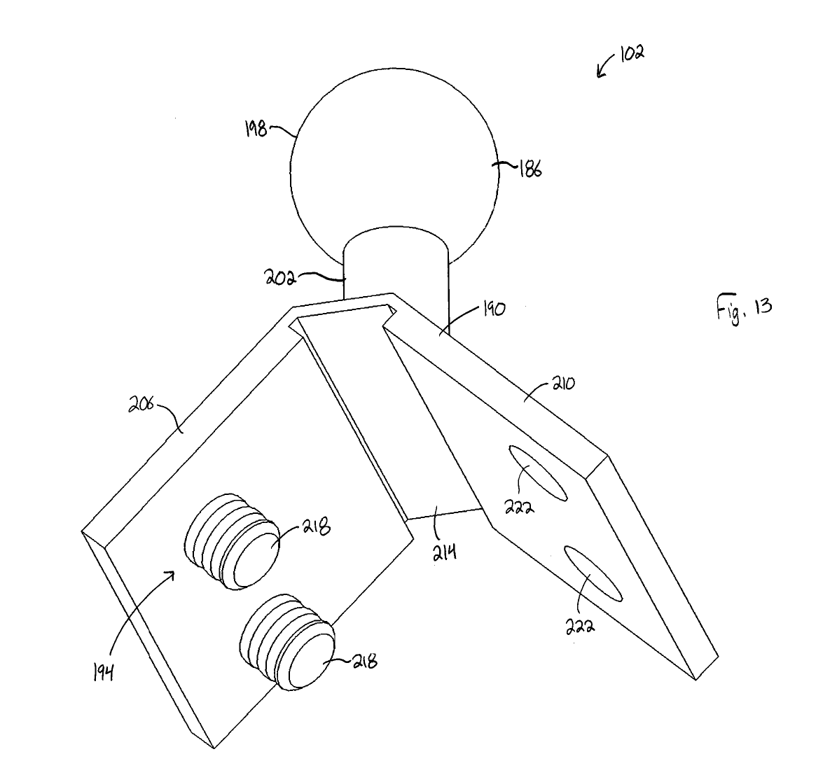

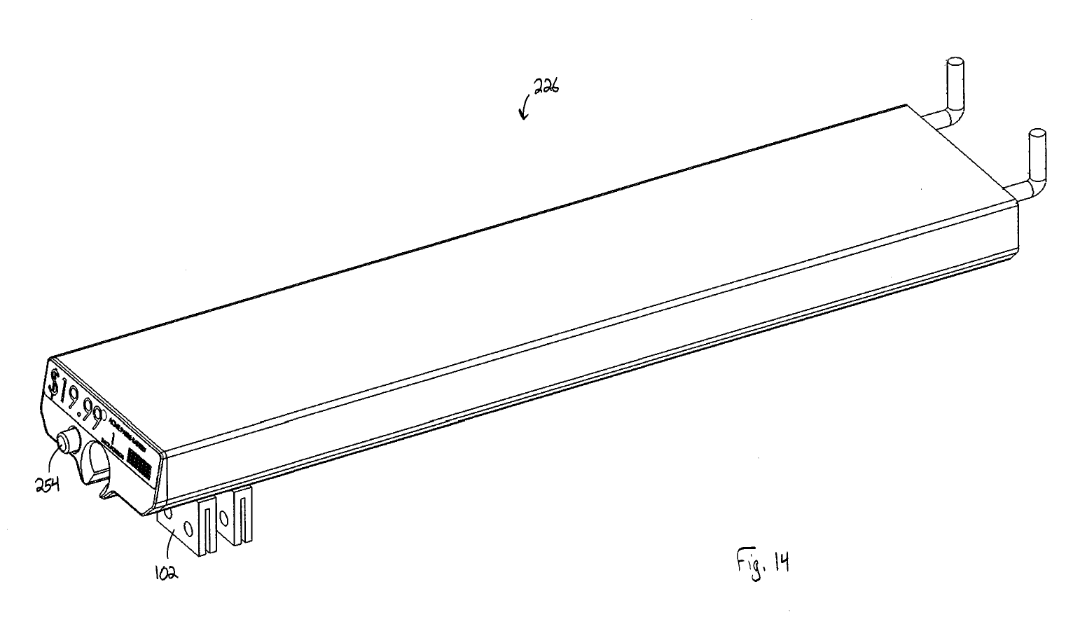

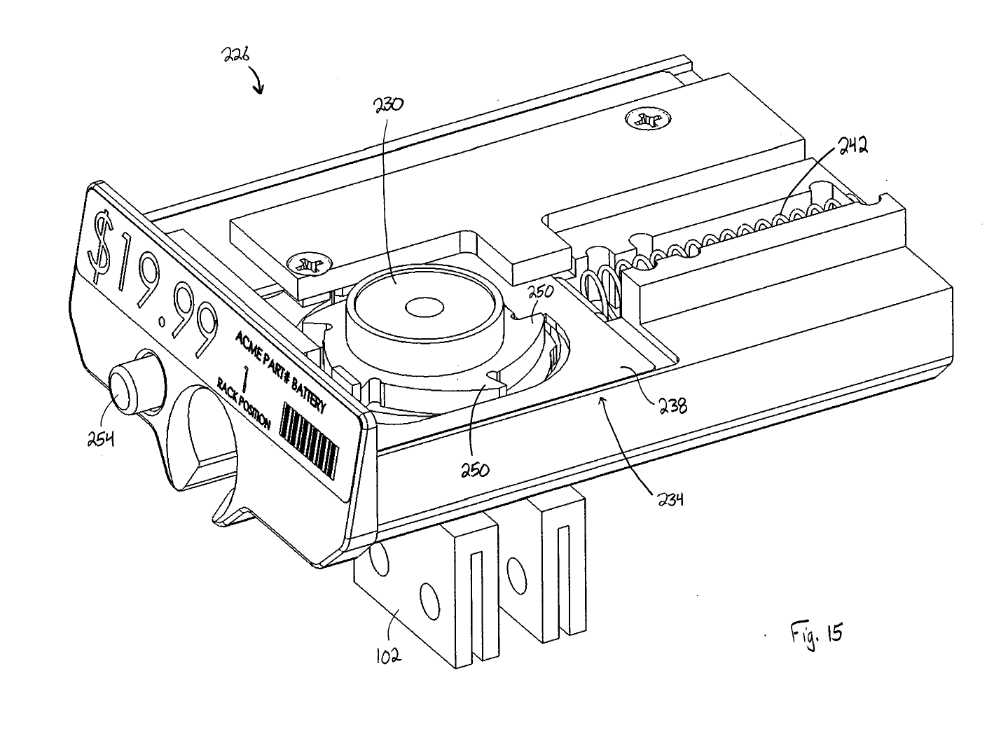

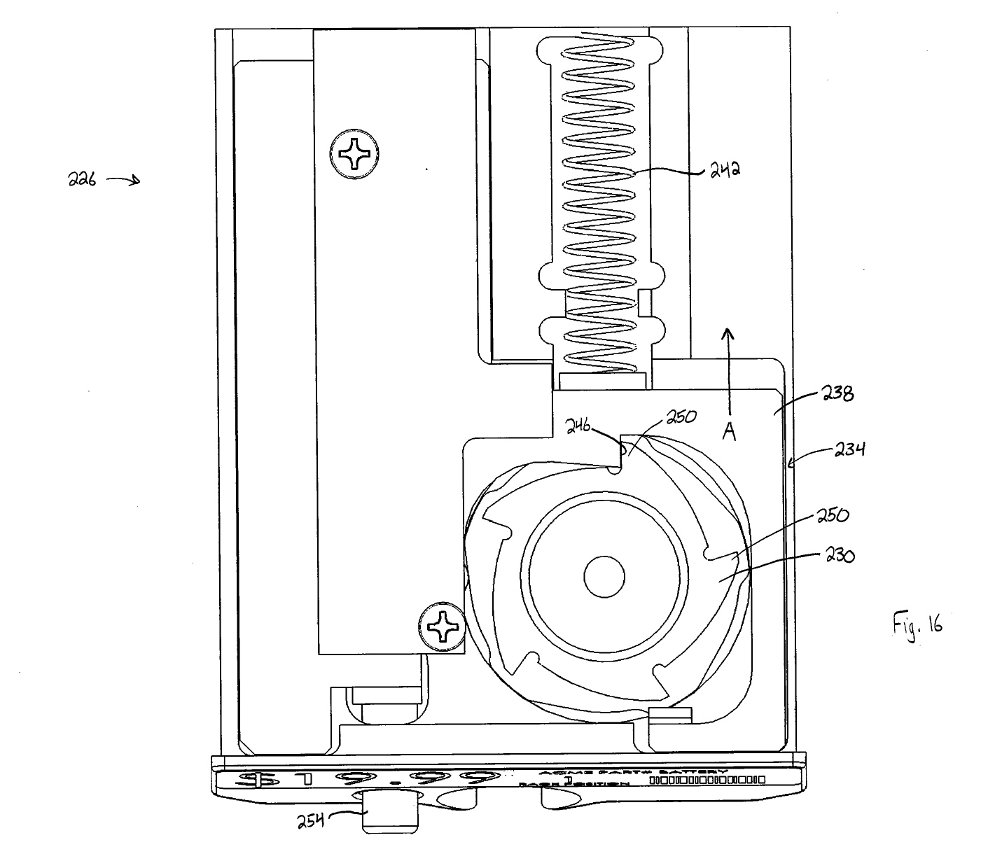

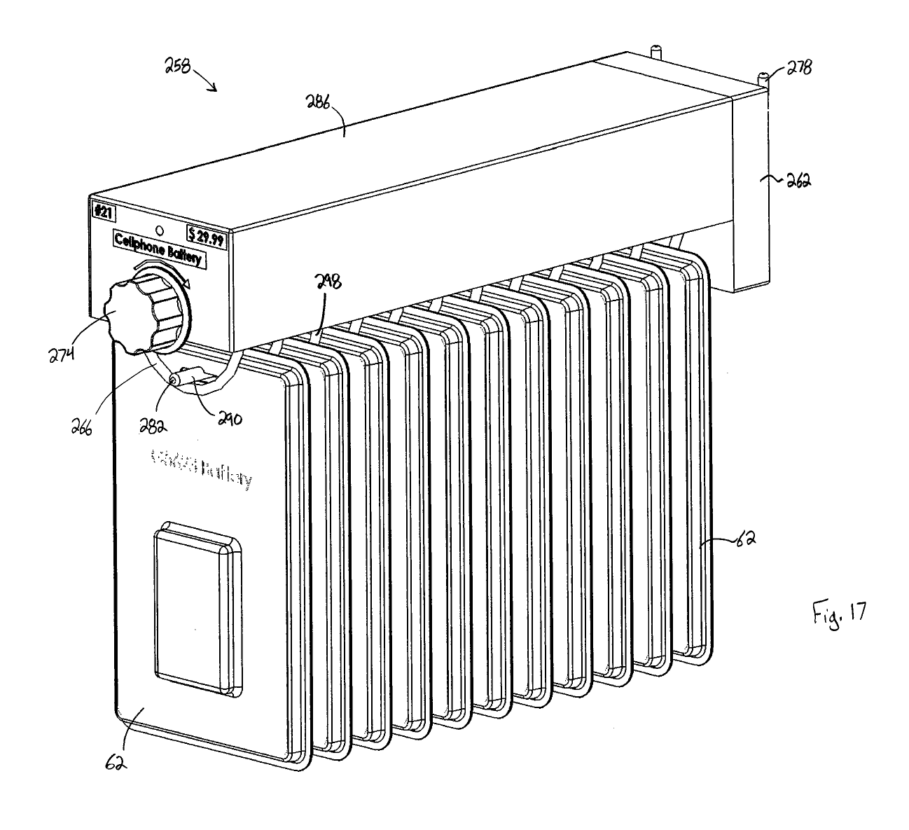

As shown in FIGS. 6 and 7, the electrical connector 86 includes a category 5 (CAT-5) cable connector. The connector 86 connects the apparatus 46 to the controller 42 (FIG. 2) to communicate with the controller 42. In other embodiments, the electrical connector 86 can include any suitable connection for providing electrical power to the inventory display apparatus 46 including, for example, speaker wire clips, screw terminals, or the like. In addition, the electrical connector 86 can allow for data communication and can include, for example, a phone jack, a USB port, or the like. In still other embodiments, the connector 86 may include a wireless transmitter and receiver. In the illustrated embodiment, the electrical connector 86 is located at a rear of the base 66 adjacent the mounting mechanism 78 such that the connector 86 is concealed from view and access. In other embodiments, the electrical connector 86 may be located on a side of the base 66.

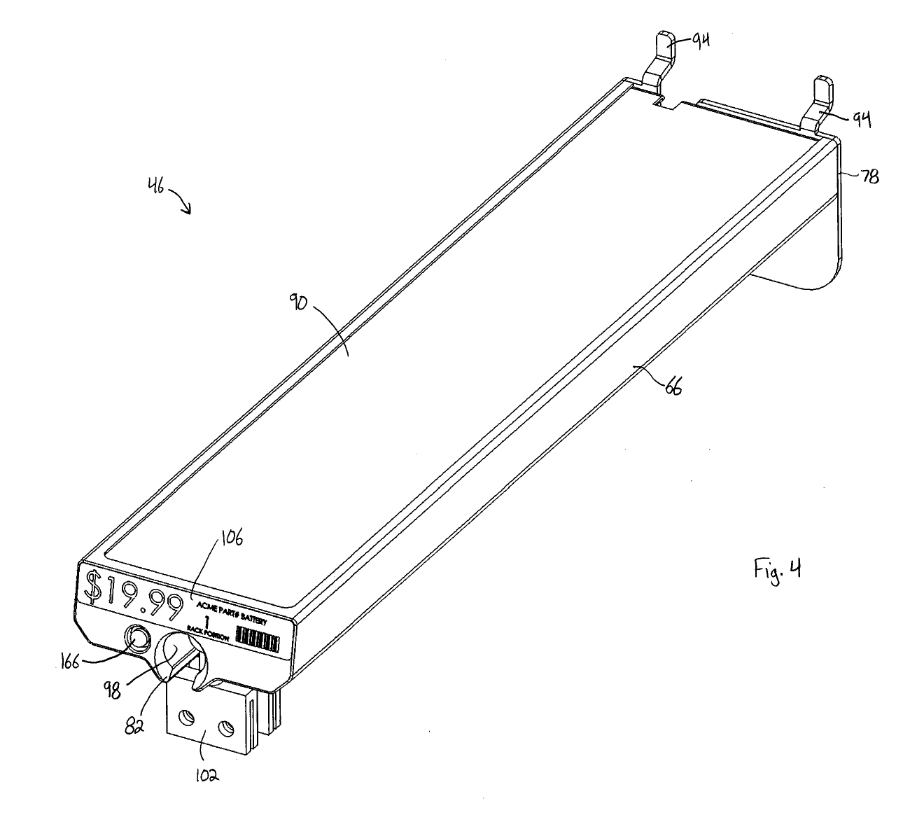

Referring to FIGS. 3 and 4, the cover 90 extends along the apparatus 46 to enclose the other components of the apparatus 46. A label 106 is affixed to the cover 90 at a front end of the base 66. The label 106 identifies characteristics of the products 62 on the apparatus 46, including the name, brand, and price of the products 62. In some embodiments, the label 106 can be a removable label held in a holder or affixed with a hook and loop fastener (e.g., VELCRO) or adhesives. In other embodiments, the label 106 can be an electronic display such as, for example, an LED, an LCD screen, or an electronic ink display. A portion of the cover 90 is removed in FIGS. 6 and 7 to illustrate the internal components, particularly the control member 70 and the locking mechanism 74, of the apparatus 46.

The control member 70 is positioned adjacent the front end of the base 66 opposite from the mounting mechanism 78. The control member 70 selectively allows removal of a package from the guide member 82. As shown in FIG. 9, the illustrated control member 70 includes a control wheel 110 and a sprocket 114. The control wheel 110 and the sprocket 114 are rotatable relative to the base 66. The control wheel 110 includes a plurality of radially-extending projections 118 that are selectively engaged by the locking mechanism 74 to inhibit rotation of the wheel 110. Referring to FIG. 7, the projections 118 form abrupt shoulder 122 that engage the locking mechanism 74 to inhibit rotation of the wheel 110 in one direction (e.g., counterclockwise).

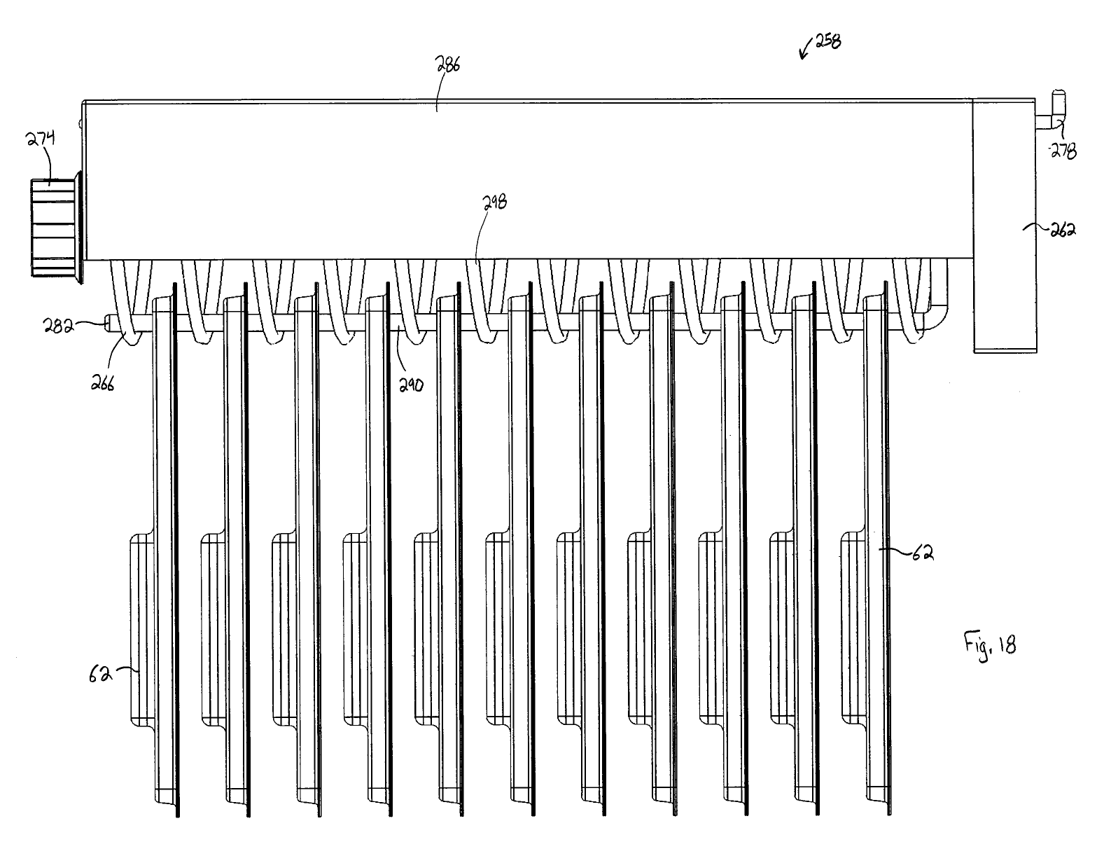

Referring back to FIG. 9, the sprocket 114 is fixed to the control wheel 110 for rotation with the wheel 110. The illustrated sprocket 114 includes four legs 126 that are shaped and contoured to engage the packaging adapter 102 of a product 62. As shown in FIG. 8, at any give time, one of the legs 126 extends into the channel 98 to block the packaging adapter 102, and thereby the product 62, from sliding out of the channel 98. When the control wheel 110 is engaged by the locking mechanism 74, the sprocket 114 is inhibited from rotating such that the packaging adapter 102 cannot be removed from the channel 98. When the control wheel 110 is not engaged by the locking mechanism 74, the sprocket 114 can rotate to move the leg 126 out of the channel 98 and allow removal of the packaging adapter 102 from the channel 98.

FIG. 10 illustrates another embodiment of a control member 130 for use with the inventory display apparatus 46. In the illustrated embodiment, the control member 130 includes an end gate 134 rather than the rotatable sprocket 114. The illustrated end gate 134 includes two fingers 138 that extend into the channel 98 to capture the packaging adapter 102 therebetween. When the control wheel 110 (or other suitable mechanism) is moved, the fingers 138 slide linearly out of the channel 98 to allow removal of the packaging adapter 102.

FIG. 11 illustrates yet another embodiment of a control member 142 for use with the inventory display apparatus 46. In the illustrated embodiment, the control member 142 includes a pivotal control arm 146 rather than the control wheel 110 and the sprocket 114. The control arm 146 pivots about a pin 150 and is biased by a torsion spring 154 such that a portion of the arm 146 extends into the channel 98 to inhibit the packaging adapter 102 from sliding out of the channel 98. When the locking mechanism (e.g., a solenoid 158) is actuated (e.g., retracted), the control arm 142 can pivot about the pin 150 out of the channel 98 to allow removal of the packaging adapter 102.

Referring back to FIGS. 6, 7, and 9, the illustrated locking mechanism 74 includes an electronically-actuated linear solenoid 162. The solenoid 162 is mounted in the base 66 adjacent the control wheel 110. The solenoid 162 is coupled to the controller 42 (FIG. 2) through the electrical connector 86 and is movable between a first state and a second state. In a normally locked state (i.e., the first state), the solenoid 162 is extended to engage one of the projections 118 on the control wheel 110 and prevent rotation of the control wheel 110 and the sprocket 114. When energized (i.e., in the second state), the solenoid 162 temporarily retracts to disengage and release the control wheel 110. In this state, the control wheel 110 and the sprocket 114 can be rotated to remove a product 62 from the channel 98. Although the illustrated solenoid 162 is electrically-actuated, in other embodiments, the locking mechanism 74 may be mechanically, electromechanically, or pneumatically actuated. In other embodiments, other suitable locking mechanisms 74 may also or alternatively be employed to selectively engage the control wheel 110.

As shown in FIGS. 4-6, the inventory display apparatus 46 also includes an indicator 166 mounted on the front end of the base 66. In the illustrated embodiment, the indicator 166 includes an LED. In other embodiments, the indicator 166 may include other suitable types of lights or visual indicators. The indicator 166 is coupled to the controller 42 to indicate to a user when the solenoid 162 is in the second, released state. For example, the indicator 166 can turn on when the solenoid 162 is retracted to notify to a user that the product 62 can be removed. In other embodiments, the indicator 166 can also indicate when the apparatus 46 is out of stock or in a loading/refill mode. In further embodiments, the apparatus 46 may include a plurality of indicators which may be visual or auditory. In still further embodiments, the indicator 166 may be located elsewhere on the base 66, such as on the mounting mechanism 78.

As shown in FIGS. 7 and 9, the inventory display apparatus 46 further includes a first switch 170 and a second switch 174 supported by the base 66 adjacent the control member 70. The switches 170, 174 are coupled to the controller 42 to help the controller 42 track operation of the apparatus 46. The first switch 170 monitors the position of the control wheel 110 relative to the base 66. The switch 170 rides along a flange 178 of the control wheel 110 and is actuated by protrusions 182 on the flange 178. After the control wheel 110 is rotated a suitable amount (e.g., a quarter turn) to remove a product 62, the switch 170 can signal the controller 42 to de-energize, and thereby re-extend, the solenoid 162. The second switch 174 monitors the presence (or lack thereof) of a packaging adapter 102, and thereby a product 62, within the channel 98.

FIGS. 12 and 13 illustrate one embodiment of the packaging adapter 62 for use with the inventory display apparatus 46. The illustrated packaging adapter 62 includes a suspension member 186, an attachment member 190, and a locking member 194. In the illustrated embodiment, the packaging adapter 62 is formed as a single piece, but may alternatively be formed from multiple separate pieces. The packaging adapter 62 is formed from any material suitable to support the weight of a displayed product and to resist separation from the package to which it is connected. For example, the packaging adapter 62 can be formed of plastic (e.g., nylon, polyethylene, polypropylene, etc.), metal (e.g., aluminum, zinc, steel, etc.), or any combination thereof. In some embodiments, the packaging adapter 62 can be integrally formed with the packaging used to house or contain the product 62 for display.

The suspension member 186 includes a head 198 that is shaped and sized to fit within the channel 98 of the inventory display apparatus 46. In the illustrated embodiment, the head 198 of the suspension member 186 is generally spherical. In other embodiments, the head 198 have may have other shapes or geometries suitable for use with the guide member 82 such as, for example, T-shaped or cylindrical. The suspension member 186 also includes a stem 202 extending downwardly from the head 198 and out of the channel 98. The suspension member 186 can travel (e.g., slide) along the length of the guide member 82 such that multiple products for display can be loaded into the guide member 82. In addition, the suspension member 186 can freely rotate 360 degrees within the guide member 82 while the adapter 46 is connected to a product 62 hanging from the apparatus 46 (as illustrated in FIG. 3). As such, a user can inspect the entire product 62 being displayed without having to bend or distort the product 62 and associated packaging.

The stem 202 connects the head 198 of the suspension member 186 to the attachment member 190. The attachment member 190 can be attached to an existing package by clamping over the package. The illustrated attachment member 190 includes two wings 206, 210 that sandwich the package therebetween. The wings 206, 210 are pivotable relative to each other via a living hinge 214.

The locking member 194 is coupled to the attachment member 190 to secure the wings 206, 210 together. The illustrated locking member 194 includes two locking bosses 218 formed on the first wing 206 and two recesses 222 formed in the second wing 210. The bosses 218 extend toward the second wing 210 and fit within the recesses 222 to secure the wings 206, 210 together around a product packaging. In other embodiments, the locking member 194 may include other means for fixing the adapter 102 to the package 62, such as, for example, rivets, snaps, adhesives, ultrasonic welding, thermoplastic welding, magnets, or the like. In some embodiments, the packaging adapter 102 can be connected to a package 62 without a locking member.

Referring back to FIG. 1, in operation, the inventory control system 30 allows a user (e.g., a customer) to select and retrieve merchandise or an item from a display for purchase. After examining the displayed merchandise, the customer can use the user interface 38 to obtain access to the selected merchandise. As discussed above, the user can interact with a remote customer service representative who can provide information and assistance to the user. In addition, the representative can authorize the release of the desired merchandise. Upon authorization, the controller 42 receives an authorization signal from the user interface 38 and transmits a release signal to the appropriate inventory display apparatus 46. By way of example, the release signal may authorize the release of one or more products 62 from a single inventory display apparatus 46, or may authorize the release of products 62 from multiple inventory display apparatuses 46. In addition, the controller 42 can activate the indicator 166 associated with the appropriate apparatus 46 to help the user identify which products 62 should be removed and where the products 62 are located.

After removal of the selected products 62, the controller 42 can communicate the change in inventory status to a device (e.g., database) connected to the system 30. As such, the system 30 can provide real time data regarding sales and inventory quantities. Such data can be used by a store or a store chain (i.e., an enterprise with multiple locations) to track sales and to effectively order, ship, and maintain inventory. As discussed above, the user interface 38 can also process payment, provide a receipt, and/or provide additional information to the user at the time of transaction.

Other aspects of the operation of the inventory control system 30 include the ability to track and communicate the quantity of new inventory loaded onto or into the inventory control apparatuses 46. When one of the inventory control apparatuses 46 is put into load mode, inventory can be added to the inventory control apparatus 30. As inventory is loaded into the apparatus 46, the control member 70 is moved (e.g., rotated) according to the number of inventory items loaded. For example, as shown in FIG. 7, the control member 70 is rotated a quarter revolution per unit of inventory loaded onto the guide member 82. In other embodiments, the control member 70 may be displaced linearly according to the number of inventory items being loaded. The inventory display apparatus 46 can communicate the number of pieces of added inventory to the controller 42. The controller 42, in turn, can communicate the number of added inventory to other devices attached to the system 30, thereby facilitating inventory control. In particular, the system 30 can compare the quantity of inventory checked out from a storeroom with the inventory loaded onto the inventory display apparatuses 46. Alternatively, the system 30 can specify a quantity of inventory to be released from a storeroom based on the current inventory loaded on the inventory display apparatuses 46. Using either method, the system 30 can verify that the released inventory was completely loaded on or into the inventory display apparatuses 46, thereby limiting the ability for store staff to steal merchandise.

FIGS. 14-16 illustrate another embodiment of an inventory display apparatus 226. The illustrated apparatus 226 is similar to the apparatus 46 discussed above, and only differences between the apparatuses 46, 226 are described below.

Similar to the inventory display apparatus 46, the illustrated apparatus 226 includes a control member 230 and a locking mechanism 234. In the illustrated embodiment, the locking mechanism 234 is a mechanical mechanism that does not require electrical power or an electronic signal to move between a first, locked state and a second, released state. The locking mechanism 234 includes a locking plate 238 and a biasing member 242. As shown in FIG. 16, the locking plate 238 surrounds the control member 230 and includes a shoulder 246 that engages a projection 250 on the control member 230 to inhibit rotation of the control member 230. The plate 238 is linearly slidable in direction A from this first state to the second state in which the shoulder 246 disengages the projection 250 to allow rotation of the control member 230. The biasing member 242 biases the plate 238 toward the first state. In the illustrated embodiment, the biasing member 242 is a coil spring, although other suitable biasing members may also or alternatively be employed.

As shown in FIGS. 15 and 16, the inventory display apparatus 226 also includes an actuator 254 that is coupled to the locking mechanism 234. In the illustrated embodiment, the actuator 254 includes a manually operable button. In other embodiments, other suitable actuators 254 may be employed. The button 254 is depressible by a user to push the plate 238 in the direction A against the bias of the biasing member 242 to move the plate 238 to the second state. When the button 254 is released, the plate 238 can slide back to the first state under the force of the biasing member 242.

In some embodiments, such as the illustrated embodiment, viscous grease is applied to surfaces of the locking plate 238 to hinder movement of the plate 238 back to the first state. For example, when the actuator 254 is released, rather than quickly sliding back to the first state, the plate 238 will slowly slide back to the first state. Such an arrangement creates a time delay for releasing or dispensing products from the apparatus 226. Accordingly, a user cannot quickly remove all of the products from the apparatus 226, but instead must actuate the button 254 multiple times and wait for the locking plate 238 to reset between actuations. The illustrated apparatus 226 thereby provides a relatively simple inventory control device that does not require power or complex electronics to control its operation.

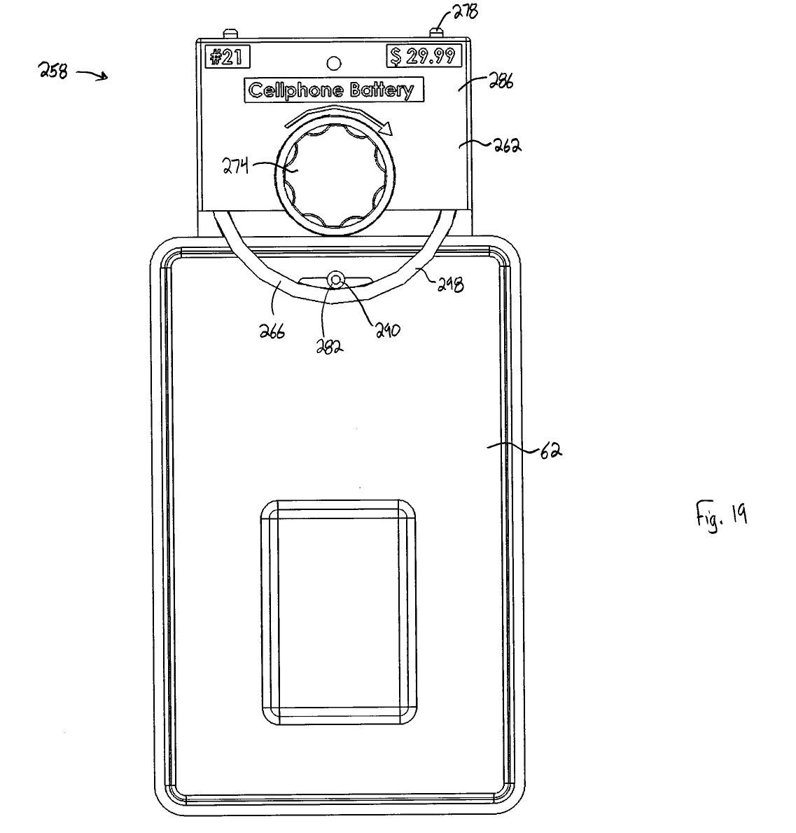

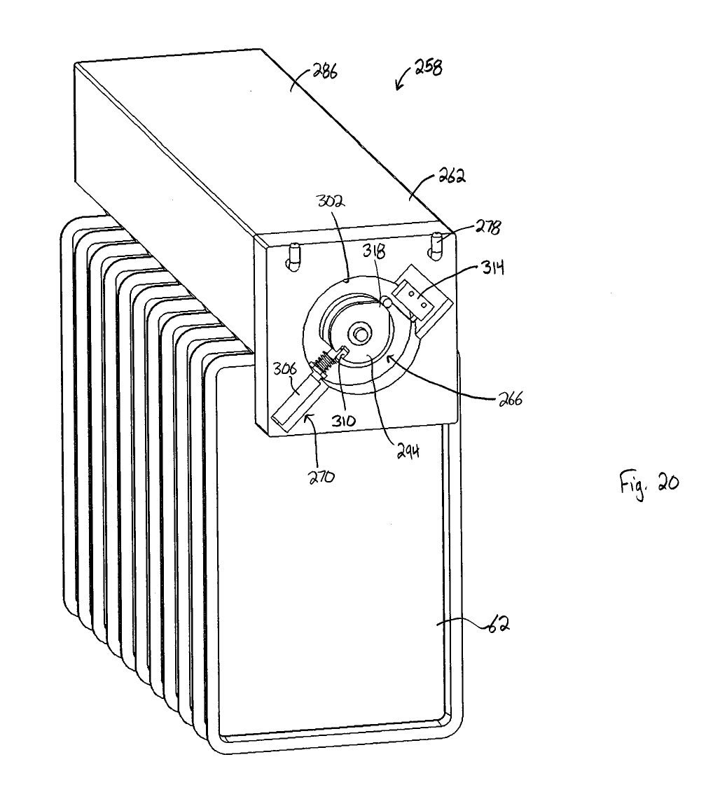

FIGS. 17-21 illustrate another embodiment of an inventory display apparatus 258. The illustrated apparatus 258 is usable with the system 30 shown in FIG. 1 instead of or in conjunction with the apparatuses 46. The inventory display apparatus 258 functions in a similar manner to the inventory display apparatus 46 described above. Differences between the apparatuses 46, 258 are described below.

The illustrated inventory display apparatus 258 includes a base 262, a control member 266, a locking mechanism 270, and an actuator 274. The base 262 includes a mounting mechanism 278 for attachment to the support structure 34, a guide member 282 for supporting a plurality of products 62, and a cover 286 that encloses the control member 266 and the guide member 282. In the illustrated embodiment, the guide member 282 includes a rod 290, or bar, that extends outwardly from the support structure 30. The cover 286 extends over and cooperates with the guide member 282 and the control member 266 to inhibit removal of merchandise from the apparatus 258. In particular, the cover 286 prevents unwinding of merchandise off of the guide member 282. In addition, the cover 286 includes features that help support the control member 266.

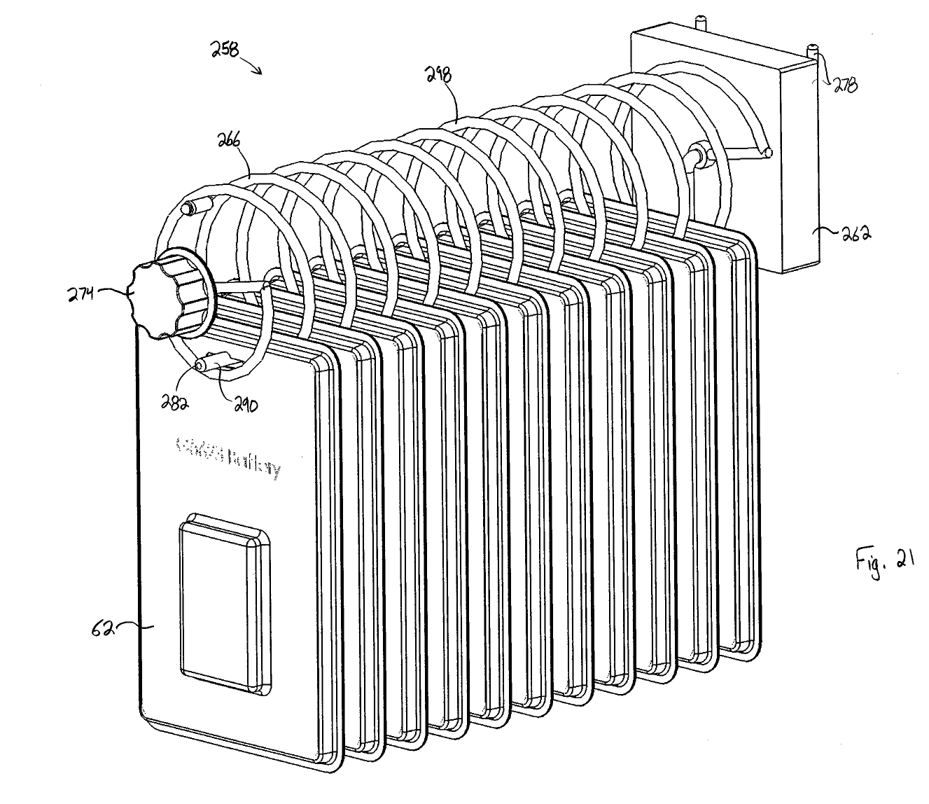

The control member 266 includes a control wheel 294 (FIG. 20) and a helical coil 298. The control wheel 294 is supported by the base 262 in a recess 302 at a rear end of the base 262. The coil 298 is coupled to the control wheel 294 for rotation with the wheel 294 and is wrapped around the rod 290. The control wheel 294 and the coil 298 are rotatable relative to the guide member 282 to allow removal of a product 62 from the guide member 282. For example, as the coil 298 is rotated, products 62 can slide along the guide member 282 away from the control wheel 294 and off an end of the rod 290.

As shown in FIG. 20, the control wheel 294, and thereby the coil 298, is selectively inhibited from rotating by the locking mechanism 270. The locking mechanism 270 is also supported by the base 262 in the recess 302 at the rear of the base 262. Similar to the locking mechanism 74 shown in FIGS. 7 and 9, the illustrated locking mechanism 270 includes an electrically-actuated linear solenoid 306. When extended (i.e., when in a first state), the solenoid 306 engages a groove 310 in the control wheel 294 to inhibit rotation of the wheel 294. When retracted (i.e., when in a second state), the solenoid 306 disengages the control wheel 294 to allow rotation of the wheel 294.

Referring back to FIGS. 17-19 and 21, the actuator 274 is supported by the base 262 at a front end of the apparatus 258 and coupled to the coil 298 of the control member 266. When the solenoid 306 disengages the control wheel 294, the wheel 294 and the coil 298 are rotatable. The actuator 274 facilitates rotation of the coil 298. In the illustrated embodiment, the actuator 274 includes a knob that allows a user to rotate the coil 298 when the wheel 294 is unlocked. In other embodiments, other suitable actuators may be employed to facilitate rotation of the coil 298. In some embodiments, the apparatus 258 can include a powered actuator instead of the manually-operable actuator 274. In such embodiments, the coil 298 can be rotated by, for example, an electromechanical or pneumatic device.

As shown in FIG. 20, the inventory display apparatus 258 further includes a switch 314 supported by the base 262 in the recess 302. The switch 314 rides along the control wheel 294 and is actuated by a protrusion 318 on the wheel 294. After the control wheel 294 is rotated a suitable amount (e.g., one complete revolution) to remove a product 62, the switch 314 can signal the controller 42 (FIG. 2) to de-energize, and thereby re-extend, the solenoid 310.

In some embodiments, the inventory display apparatus 258 may include a manual release that functions as a refill mode mechanism. The manual release may be connected to the base 262 and may engage the control member 266. When actuated, the release would allow the control member 266 to be moved (e.g., rotated) in a direction that allows for products to be added to the guide member 282, but not removed from the guide member 282. For example, the release may include a finger that lifts the solenoid 306 out of the groove 310 in the control wheel 294, but only allows rotation of wheel 294 in one direction. In other embodiments, the refill mode mechanism can be any suitable device, including electromechanical or pneumatic devices.

As described and shown herein, embodiments of the invention can be used with existing store display fixtures (e.g., racks, shelves, pegboards, etc.). Accordingly, the apparatus, system, and method described above for displaying and controlling inventory provide a solution to the problems faced by retailers in the display and control of merchandise without requiring expensive modifications to store layouts or the purchase of entire display fixtures.

Further embodiments of the invention can be used in non-retail settings. Such embodiments can include stationary and mobile units for the rationing of goods in different locations for different purposes, for example, in schools, prisons, police and fire stations, and state and government offices. Still further embodiments can be used to ration supplies, including for example, to members of the armed services, to members of the public during an emergency/disaster recovery, or at food shelters. Yet further embodiments can be used in public transport stations, airports, or the like to display and vend passes, tickets, or the like.

Still further embodiments of the invention can be used as unattended vending kiosks as an alternative to vending machines because the invention can be configured to fit in different space constraints and can display and dispense items not well suited for vending machine. Still further embodiments of the present invention can be used in temporary locations at a fraction of the cost of a vending machine. In addition, for the reasons stated above, embodiments of the invention allow for greater customer interaction with the displayed merchandise not possible from a vending machine.

Further embodiments of the invention can be used by a user to temporarily check out goods for use for later return to the device. Such embodiments can be used in rental or loan settings including, for example, in gyms or health clubs to facilitate the lending of equipment, or at libraries for checking out and returning materials such as books, CD's, DVD's, etc. In such embodiments, the user can be identified by the system both during the check out and check in process to assure that the item returned is properly identified as being returned by an authorized user.

Therefore, embodiments of the invention provide apparatuses, systems, and methods for displaying and controlling inventory, which can be used to better control displayed inventory that allows direct user interaction with the displayed inventory and releases the controlled inventory after granting access permission. It is to be understood that the invention is not limited in its application to the details of construction and the arrangement of components set forth in the description herein or illustrated in the drawings. The invention is capable of other embodiments and of being practiced or of being carried out in other ways.

Various features and advantages of the invention are set forth in the following claims.

1. An apparatus for displaying merchandise on a support structure, the apparatus comprising:
a base configured to couple to the support structure, the base including a guide member configured to support a plurality of items for display;
a control member supported by the base, the control member including a control wheel that is rotatable relative to the guide member to selectively allow removal of an item from the guide member; and
a locking mechanism supported by the base, the locking mechanism movable between a first state, in which the locking mechanism engages the control wheel to inhibit rotation of the control wheel relative to the guide member, and a second state, in which the locking mechanism disengages the control wheel to allow rotation of the control wheel relative to the guide member.

2. The apparatus of claim 1, wherein the control wheel includes a projection, wherein the locking mechanism engages the projection when in the first state and disengages the projection when in the second state.

3. The apparatus of claim 1, wherein the locking mechanism includes an electronically-actuated member that is movable between the first state and the second state.

4. The apparatus of claim 3, wherein the electronically-actuated member includes a solenoid.

5. The apparatus of claim 1, wherein the locking mechanism includes a manually-actuated member that is movable between the first state and the second state.

6. The apparatus of claim 5, wherein the manually-actuated member includes a plate that engages the control wheel in the first state and disengages the control wheel in the second state, and wherein the locking mechanism further includes a biasing member to bias the plate toward the first state.

7. The apparatus of claim 6, further comprising an actuator supported by the base, wherein the actuator is operable to move the plate to the second state against the bias of the biasing member.

8. The apparatus of claim 1, wherein the guide member includes a channel configured to receive portions of the plurality of items.

9. The apparatus of claim 8, wherein the control member further includes a sprocket coupled to the guide wheel for rotation with the guide wheel, wherein a portion of the sprocket extends into the channel to inhibit removal of the item from the channel, and wherein the portion of the sprocket is movable out of the channel when the locking mechanism is in the second state that allows rotation of the control wheel.

10. The apparatus of claim 1, wherein the guide member includes a rod configured to support the plurality of items.

11. The apparatus of claim 10, wherein the control member further includes a coil coupled to the guide wheel for rotation with the guide wheel, wherein the coil is wrapped around the rod to inhibit removal of the item from the rod, and wherein the coil is rotatable relative to the rod when the locking mechanism is in the second state that allows rotation of the control wheel.

12. The apparatus of claim 11, further comprising an actuator coupled to the coil, wherein the actuator is operable to rotate the coil relative to the rod when the locking mechanism is in the second state.

13. The apparatus of claim 1, further comprising an indicator supported by the base, wherein the indicator is operable to indicate when the locking mechanism is in the second state.

14. An apparatus for displaying merchandise on a support structure, the apparatus comprising:
a base configured to couple to the support structure, the base including a guide member configured to support a plurality of items for display;
a control member supported by the base, the control member movable relative to the guide member to selectively allow removal of an item from the guide member; and
a locking mechanism supported by the base, the locking mechanism including an electronically-actuated member that is movable between a first state, in which the locking mechanism inhibits movement of the control member relative to the guide member, and a second state, in which the locking mechanism allows movement of the control member relative to the guide member.

15. The apparatus of claim 14, wherein the electronically-actuated member includes a solenoid.

16. The apparatus of claim 14, wherein the control member includes a control wheel having a projection, wherein the electronically-actuated member engages the projection when in the first state and disengages the projection when in the second state.

17. The apparatus of claim 14, wherein the guide member includes a channel configured to receive portions of the plurality of items, wherein the control member includes a sprocket, wherein a portion of the sprocket extends into the channel to inhibit removal of the item from the channel, and wherein the portion of the sprocket is movable out of the channel when the electronically-actuated member is in the second state that allows movement of the control member.

18. The apparatus of claim 14, wherein the guide member includes a rod configured to support the plurality of items, wherein the control member includes a coil, wherein the coil is wrapped around the rod to inhibit removal of the item from the rod, and wherein the coil is rotatable relative to the rod when the electronically-actuated member is in the second state that allows movement of the control member.

19. An apparatus for displaying merchandise on a support structure, the apparatus comprising:
a base configured to couple to the support structure, the base including a guide member configured to support a plurality of items for display;
a control member supported by the base, the control member movable relative to the guide member to selectively allow removal of an item from the guide member;
a locking mechanism supported by the base, the locking mechanism movable between a first state, in which the locking mechanism inhibits movement of the control member relative to the guide member, and a second state, in which the locking mechanism allows movement of the control member relative to the guide member; and
an actuator supported by the base, the actuator being manually operable to actuate one of the control member and the locking mechanism to release the item from the guide member.

20. The apparatus of claim 19, wherein the actuator is coupled to the locking mechanism, and wherein the actuator is operable to move the locking mechanism to the second state.

21. The apparatus of claim 20, wherein the locking mechanism includes a plate and a biasing member, wherein the plate is movable between the first state and the second state, wherein the biasing member biases the plate toward the first state, and wherein the actuator is operable to move the plate to the second state against the bias of the biasing member.

22. The apparatus of claim 21, wherein movement of the plate toward the first state is hindered to create a time delay for dispensing the item from the guide member.

23. The apparatus of claim 22, wherein a surface of the plate is coated in viscous grease to hinder movement of the plate.

24. The apparatus of claim 19, wherein the actuator is coupled to the control member, and wherein the actuator is operable to move the control member relative to the guide member when the locking mechanism is in the second state.

25. The apparatus of claim 24, wherein the guide member includes a rod configured to support the plurality of items, wherein the control member includes a coil, wherein the coil is wrapped around the rod to inhibit removal of the item from the rod, and wherein the actuator is operable to rotate the coil relative to the rod.

26. The apparatus of claim 19, wherein the actuator includes a manually-operable button.

27. The apparatus of claim 19, wherein the actuator includes a manually-operable knob.

28. A system for displaying merchandise comprising:
a support structure;
a plurality of inventory display apparatuses, each inventory display apparatus including
a base mounted to the support structure, the base including a guide member configured to support a plurality of items for display,
a control member supported by the base, the control member movable relative to the guide member to selectively allow removal of an item from the guide member, and
a locking mechanism supported by the base, the locking mechanism movable between a first state, in which the locking mechanism inhibits movement of the control member relative to the guide member, and a second state, in which the locking mechanism allows movement of the control member relative to the guide member;
a controller coupled to the plurality of inventory display apparatuses, the controller operable to control the locking mechanism of each inventory display apparatus; and
a user interface mounted to the support structure and coupled to the controller, the user interface operable to transmit a signal to the controller to selectively move the locking mechanism of each inventory display apparatus from the first state to the second state.

29. The system of claim 28, wherein the user interface displays information regarding the plurality of items displayed by the plurality of inventory display apparatuses.

30. The system of claim 28, wherein the controller monitors at least one of the type, quantity, and location of merchandise within the system.

31. The system of claim 28, further comprising a network connection coupled to one of the controller and the user interface.

32. The system of claim 31, wherein the network connection is configured to connect the user interface to a remotely located customer service representative.

33. The system of claim 28, wherein the user interface includes at least one of a touch screen, a microphone, a speaker, a camera, and a card reader.

34. The system of claim 28, wherein each inventory display apparatus includes an indicator that indicates when the locking mechanism is in the second state, and wherein the controller controls operation of the indicator.
